(19) United States
(12) Patent Application Publication
(10) Pub. No.: US 2013/0058546 A1
(43) Pub. Date: Mar. 7, 2013

(54) COLOMETRIC SCALE

(71) Applicants: Giancarlo DI VELLA, Bari (IT); Emilio Nuzzolese, Bari (IT); Margherita Neri, Foggia (IT)

(72) Inventors: Giancarlo DI VELLA, Bari (IT); Emilio Nuzzolese, Bari (IT); Margherita Neri, Foggia (IT)

(73) Assignee: UNIVERSITA' DEGLI STUDI DI, Bary (IT)

(21) Appl. No.: 13/225,844

(22) Filed: Sep. 6, 2011

(51) Int. Cl. G06K 9/00

(52) U.S. Cl. 382/128

(57) ABSTRACT

A device for use when taking photographs used in the clinical and/or medico-legal and forensic sector, to establish the age of traumatic cutaneous lesions in the form of bruising.

### BACKGROUND ART

Forensic medicine studies the application of medical science to legal questions and often makes use of “forensic photography”, a term that indicates medico-legal imaging, comprising taking photographs of the crime scene in order to reproduce it accurately, and taking photographs of important findings on the body of victims, in the interest of legal authorities. In this sector, pathologists are frequently asked to determine the age of a traumatic lesion in the form of bruising relevant for the purposes of investigations.

In June 1996, a study was conducted in the United States of America, comprising a part specifically dedicated to determining the age of bruises. In the report, chronological correlations were predicted between bruise colors and the age of the lesion, according to the following pattern: red/0-2 days; blue-purple/2-5 days; green/5-7 days; yellow/7-10 days; brown/10-14 days.

Notwithstanding the valid help represented by this pattern, evaluation of bruise color remains extremely subjective and also difficult to evaluate and re-examine a posteriori, above all in view of the fact that, even when photographs are able to reproduce the original colors of the lesion at the time they are taken, over time they can undergo significant color variations and/or alterations caused by the action of atmospheric agents, light and other factors.

For some time systems and devices have been available to evaluate the morphological and dimensional properties of a lesion in the form of bruising, such as metric and angular reference, without however being of help in determining the age thereof, as there is no standard color reference that is reliable over time.

The basic model of currently used metric devices of ruler type provided with metric and angular reference, and levels of black/white, was approved in 1988, in accordance with the scientific publication Hyzer W G, Krauss T C. The Bite Mark Standard Reference Scale—ABFO No. 2. Journal of Forensic Science, 1988 March;33(2):498-506.

In the scientific literature of reference, there are numerous mentions of the need to standardize photographic and colorimetric procedures, in order to better define the age of lesions in the form of bruising, also and above all in evaluations carried out a posteriori, i.e. some time after the photographs were taken, for example as described in Georgieva L, et al. Computer-aided System for the Bruise Color's Recognition, International Conference on Computer Systems and Technologies—CompSysTech' 2005.

### DESCRIPTION OF THE INVENTION

The object of the present invention is to provide a device that is easy to use while shooting video and taking photographs of traumatic lesions in the form of bruising, which makes it possible to determine the age thereof—based on colorimetry—which is also reliable and reproducible a posteriori through analysis of the image.

Therefore, the present device offers the advantage of a double reference, dimensional and colorimetric, which, positioned in proximity of the cutaneous lesion in question, allows simultaneous evaluation of the morphological properties and of the age thereof.

The device for taking photographs of traumatic lesions in the form of bruising is an aid that improves the technique of forensic photography, making the colors of said photographs reliable and reproducible, as well as stable over time.

These and other objects and related advantages which will be more apparent from the description below are achieved by a device for evaluating traumatic lesions in the form of bruising; this consists of a ruler provided with metric and angular references and, moreover, with a colorimetric scale, which can be advantageously used while taking photographs of a lesion in the form of bruising of cutaneous soft tissue.

The device according to the invention therefore consists of an L-shaped ruler, provided with metric references (for example 5 cm per side), angular references (for example 3 circles), a scale to determine the levels of black/white (for example 3 circles divided into four white/black sectors), and also provided with colorimetric references. Said colorimetric references are given by 6 (six) colors pertinent to the various skin color variations of a traumatic lesion in the form of bruising, and namely: dark red, bluish, purple, greenish, yellow, light brown.

The device of the present invention represents a useful reference in taking photographs of lesions in the form of bruising of cutaneous tissue, such as bite marks, ecchymoses, hematomas, etc., not only for forensic evaluation and for determining the age thereof, but also in order to monitor lesions and the evolution thereof in living subjects.

The bruise is a lesion caused by the action of a mechanical force which can cause the loss of superficial epithelial layers, rupture of vascular structures (arteries and veins) with blood leakage into the surrounding interstitial tissue or, when of particular intensity, lesions to the deep organs (viscera, bones, etc.). Bruising can therefore involve small cutaneous vessels, subcutaneous tissue, muscle or can damage deeper structures, such as bones.

Therefore, photographs are taken of each traumatic lesion in the form of bruising of forensic interest, to allow it to be recorded and evaluated also a posteriori; the metric reference in the field of photography is essential for metric-morphological evaluations. Traumas capable of causing bruises can derive from a variety of situations, for example they can be of accidental nature, they can be caused by the unlawful conduct of third parties and they can also be the consequence of surgical operations.

The shape of the lesions in the form of bruising can at times correspond to that of the object that caused them; however, the original shape of the lesion is always subject to variations due to advance of reparative phenomena, making identification of the instrument that caused them more complex as time passes. Lesions in the form of bruising are extremely important evidence as they are often indicators of abuse or maltreatment of minors or the elderly, or in any case of acts of violence in a domestic environment; recording the color of the cutaneous lesion can help to understand the phenomenon, as although lesions are often repeated they are caused at different times.

The colorimetric references present on the device of the present invention are of great help in ascertaining the age of the lesion and can therefore contribute, from a scientific and medico-legal viewpoint, to understanding unlawful acts previously not known and to defending the victims.

The device according to the invention therefore finds widespread use in the case in which photographs must be taken for clinical, but above all for medico-legal use and for use in forensic dentistry, with particular reference to the needs of Legal Authorities to understand the age of the lesions.

From the point of view of practical application, the device is used as double reference, dimensional and colorimetric, positioned in proximity of the cutaneous lesion to be filmed or photographed, following the criteria proper to forensic photography, with particular relation to the shooting frames.

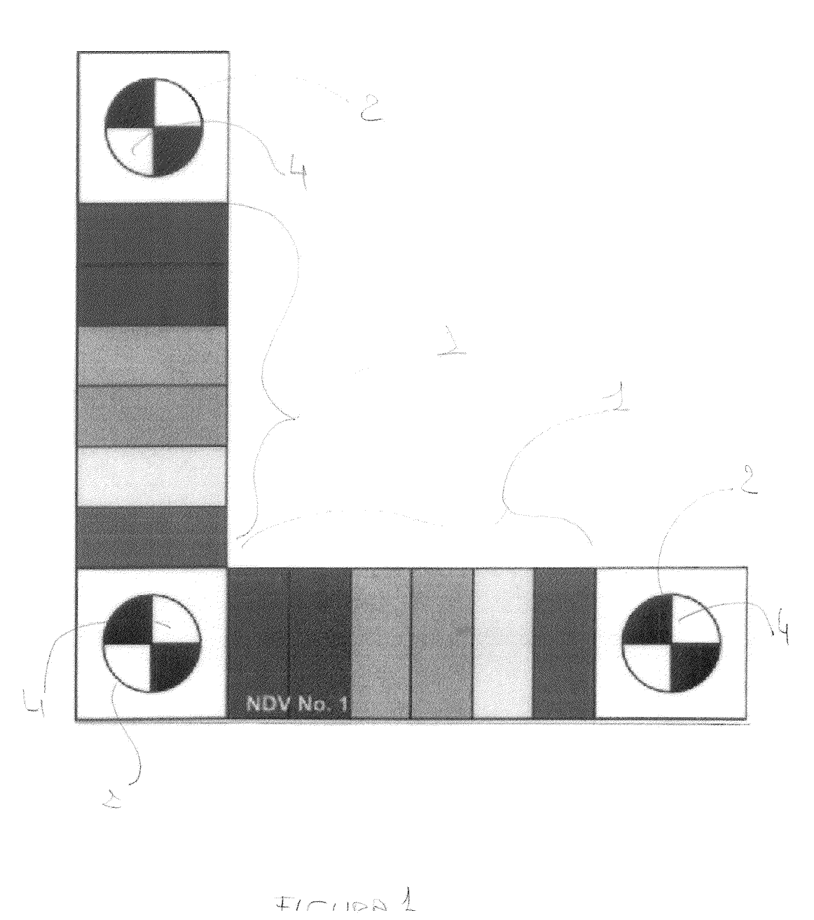

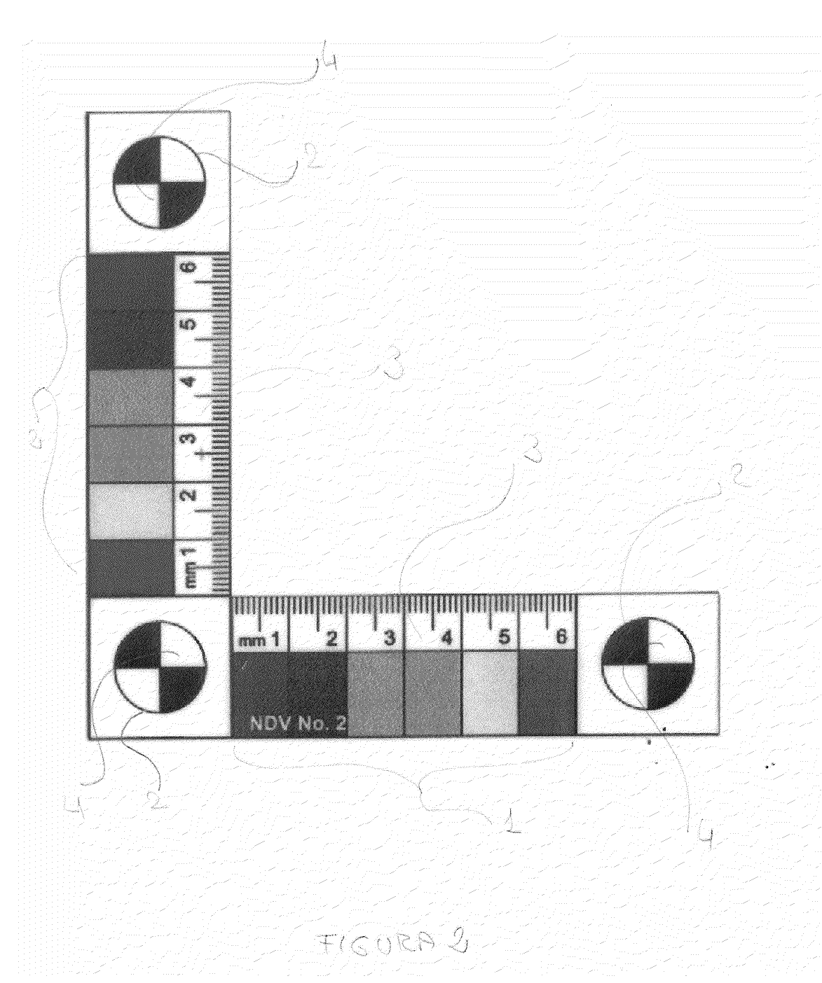

An embodiment of the device according to the invention is indicated in the accompanying FIGS. 1 and 2, provided purely by way of non-limiting example of the present invention.

FIG. 1 shows the device according to the invention provided with the colorimetric scale 1, and with the angular reference 2, while FIG. 2 shows the same device according to the invention, but in an embodiment provided not only with the colorimetric scale 1 and the angular reference 2, but also with the metric reference 3.

The innovative component of the invention is represented by the presence of the colorimetric reference scale, which allows the evolving color stages of a traumatic lesion to be taken into account. Besides the metric and angular reference already present in models according to prior art, the addition of a colorimetric reference scale, as well as the metric and angular references, on the device according to the invention, makes it possible to standardize the colors recorded while taking photographs of the lesion to be evaluated; it represents a reliable, trustworthy and reproducible aid in interpreting the age of the lesion, especially when studied a posteriori, using only images available after healing has taken place.

Moreover, in the case of living subjects, photographs of the same lesion taken, again using the device according to the present invention, at different moments in time (e.g. at a distance of 2, 5-7, 14-15 days), allow comparative evaluation of the same images using the initial colorimetric standard of reference, to the benefit of a correct method of chronological evaluation of the lesion and to the benefit of those who may be called to express expert opinions on these lesions, having only the photographs taken by third parties at their disposal.

The device according to the invention is therefore constituted by a ruler provided with metric and angular references and is integrated with colorimetric references, to be used while taking photographs of a lesion in the form of bruising of cutaneous soft tissue. The state of the art provides for the use of rulers of various dimensions and with metric and angular references; rulers integrating the colorimetric reference relating to the evolution of the original lesion are currently not marketed or accessible to the public in any other form, nor are they known.

1. A device for evaluating traumatic lesions in the form of bruising, which consists of a ruler provided with at least one angular reference (2), with at least one scale for determining the levels of black/white (4) and is also provided with at least one colorimetric reference (1).

2. The device according to claim 1, characterized in that said ruler is L-shaped, is provided with three references of angular type (2), is provided with three scales for determining levels of black/white (4), and is also provided with two colorimetric references (1).

3. The device according to claim 1, characterized in that said ruler is also provided with at least one metric reference (3).

4. The device according to claim 2, characterized in that said ruler is also provided with two metric references (3).

5. The device according to claim 2, characterized in that said colorimetric reference (1) is produced using six colors corresponding to the skin color variations typical of a traumatic lesion in the form of bruising.

6. The device according to claim 5, characterized in that said six colors are selected from: dark red, bluish, purple, greenish, yellow, light brown.

7. Use of the device according to claim 1 for taking photographs of lesions in the form of bruising of cutaneous tissues for forensic evaluation and for determining the dating thereof.

8. Use of the device according to claim 1 for taking photographs of lesions in the form of bruising of cutaneous tissues in order to monitor said lesions and to monitor the evolution thereof in living subjects.

9. Use of the device according to claim 1 for taking photographs of lesions in the form of bruising of cutaneous tissues, usable both in the clinical and/or medico-legal and forensic dentistry sector, to determine the age of said lesions.

10. A process for evaluating and/or aging a lesion in the form of bruising of cutaneous tissues, which comprises positioning of the device according to claim 1, in proximity of the cutaneous lesion to be evaluated/aged, according to the criteria proper to forensic photography, particularly referring to the shooting frames.
